(19) United States
(12) Patent Application Publication
(10) Pub. No.: US 2024/0362457 A1
(43) Pub. Date: Oct. 31, 2024

(54) System and Method for Sensing a State of a Device with Continuous-Time Dynamics

(71) Applicant: Mitsubishi Electric Research Laboratories, Inc., Cambridge, MA (US)

(72) Inventors: Pu Wang, Cambridge, MA (US); Cristian Vaca-Rubio, Aalborg (DK); Toshiaki Koike Akino, Cambridge, MA (US); Ye Wang, Andover, MA (US); Petros Boufounos, Winchester, MA (US)

(21) Appl. No.: 18/308,126

(22) Filed: Apr. 27, 2023

(51) Int. Cl. G06N 3/0455; G05D 1/02

(52) U.S. Cl. CPC G06N 3/0455

(57) ABSTRACT

A system for sensing a state of a device is provided. The system includes an autoencoder comprising an encoder, a latent subnetwork, and an extended decoder. The encoder encodes each input data point of input data from an input state space into a latent space to produce latent data points and propagates the latent data points with a neural Ordinary Differential Equation (ODE) to estimate an initial point of latent dynamics of the device in the latent space. The latent subnetwork propagates the initial point till a time index of interest using the neural ODE to produce a state of latent dynamics of the device at the time index of interest. The extended decoder decodes the state of latent dynamics of the device into an output state space different from the input state space to produce output data including the state of the device at the time index of interest.

### TECHNICAL FIELD

The present disclosure relates to tracking systems and more particularly to a system and a method for sensing a state of a device with continuous-time dynamics using an autoencoder adapted for continuous-time state space transformation.

### BACKGROUND

A state of a device (e.g., a location of a mobile robot with or without dedicated sensors) may be sensed using different approaches. For example, Wi-Fi fingerprinting approach may be used for indoor localization of the device. With commercial-of-the-shelf (COTS) Wi-Fi devices, Wi-Fi measurements, such as coarse-grained received signal strength indicator (RSSI), mid-grained beam training measurements at 60 GHz, and fine-grained channel state information (CSI) at sub-7 GHZ, may be fingerprinted.

Machine learning and advanced deep learning methods have been applied to the Wi-Fi fingerprinted measurements. For instance, a pretrained fusion network between the CSI at sub-7 GHz and the beam training measurements at 60 GHz is used for both localization and device-free sensing tasks. However, such approaches are frame-based approaches, i.e., coordinate of the device is inferred from a current Wi-Fi frame, without integration of past measurements or previous trajectory history. On the other hand, sequence-based approaches take consecutive Wi-Fi frames as input, and state estimation (e.g., Kalman filter-like approaches) and recurrent neural networks can be applied for trajectory estimation with the RSSI and CSI at sub-7 GHz. However, the sequence-based approaches have not been applied to mm Wave Wi-Fi localization due to the intermittent nature of the Wi-Fi beam training measurement.

Therefore, there is still a need for a system and a method for sensing the state of the device.

### SUMMARY

It is an object of some embodiments to provide a system and a method for sensing a state of a device with continuous-time dynamics using an autoencoder adapted for continuous-time state space transformation. An autoencoder is a type of artificial neural network used to learn efficient encodings of unlabeled data (unsupervised learning). The autoencoder includes an encoder and a decoder. The encoder is configured to encode each input data point of input data from an input space into a latent space. The decoder is configured to decode each encoded data point from the latent space into an output space to produce the output data. One of the fundamental features of the autoencoder is that the input data and the output data belong to the same state space. A state space of the input data is referred to as input state space and a state space of the output data is referred to as output state space. The state space can vary based on applications. Examples of the state space include pixel intensities for face recognition applications and temperature values for thermo-comfort applications. But regardless of the applications, the input data and the output data of the autoencoder belong to the same state space. This “limitation” has been considered a problem but rather as a feature of the autoencoder allowing to perform unsupervised training of the autoencoder.

However, it is an objective of some embodiments to address this limitation to extend the autoencoder to data transformation among different state spaces. Examples of such transformation include transforming signal waveform into locations, temperature into humidity, voltages into currents, etc. Such a transformation is advantageous in many technical fields including location tracking by transforming Wi-Fi signals, anomaly detection, smart grid applications, and data completeness applications.

Some embodiments are based on the realization that such state space transformation can be performed by extending the autoencoder with multiple decoders. To that end, according to an embodiment, the autoencoder includes the encoder, the decoder, and an extended decoder. In some embodiments, the autoencoder includes a plurality of extended decoders. The decoder decodes to the same state space as the input data. The decoder is beneficial for enforcing principles of AI module with the autoencoder. The extended decoder is used to train the encoder to find such latent space that carries information indicative of a partial or full state space of the extended decoder. The objective here is to train the autoencoder to find such a latent space that carries not only information of the state space of the input data but the information indicative of the corresponding data in another state space of interest.

However, some embodiments are based on another realization supported by experiments, that such a state space transformation is not very practical for static data or for static devices. This is because at least in part that the latent space carrying information for more than one state space is too small to be reliable. To that end, some embodiments extended the autoencoder to dynamical devices represented by autoencoders with dynamic latent space. The autoencoder extended to the dynamical devices is referred to as a dynamic autoencoder.

In contrast with the static data, the dynamic autoencoder operates on time-series data that carry information about dynamics of the device. The state of such dynamic devices is represented by state variables of different state spaces. Hence, in contrast with the latent space of the autoencoder capturing essence of the input data, a latent space of the dynamic autoencoder can capture the essence of the dynamics. Because different state variables can carry redundant information about the dynamics of the device, the latent space of the dynamic autoencoder can carry information of different state variables in different state spaces allowing the state space transformation.

Some embodiments are based on the observation that, to train such a dynamic autoencoder with multiple decoders decoding into different state spaces, there is a need to have labeled training data in a subset of the state space different from the input state space. The labeled training data necessitate supervised machine learning and are usually difficult to get. Hence, while in theory, any dynamical autoencoder can be extended to the multiple decoders to adapt the dynamic autoencoder to the state space transformation, in practice can be a significant imbalance between unlabeled training data from the input state space and labeled training data from a desired output state space.

Some embodiments are based on the observation that the labeled training data and input data for different decoders may be acquired at different time instances. For instance, the input data is obtained from a Wi-Fi device while the labeled training data are obtained from a robot wheel encoders or LiDAR sensors. These sensors may not be synchronized together to the same time axis. Moreover, frame rates for the input data and the labeled training data can be different. This calls for a framework that learns a shared latent space in continuous-time fashion. As a result, the continuous-time shared latent space can register a latent state at any query time instance. A queried latent state can be further transformed to reconstruct the input data or the labeled training data at the extended decoder.

To that end, it is an objective of some embodiments to adapt the dynamic autoencoder to imbalanced training with multiple decoders decoding into different and complementary state spaces. The imbalanced training includes one or a combination of different amounts of training data in different state spaces, a different time resolution of the training data in the different state spaces, a different quantization of the training data in the different state spaces, and a different time alignment of the training data in different state spaces.

Some embodiments are based on the realization that such imbalanced training can be performed for a state of the device with continuous-time dynamics because continuation of the dynamics makes the imbalance of the training data irrelevant. However, the dynamic autoencoder has a discrete nature to operations. To that end, there is a need to transform the dynamic autoencoder to capture continuous nature of the continuous-time dynamics of the device for any imbalances of the training data.

Some embodiments are based on the realization that the continuous-time dynamics can be defined by Ordinary Differential Equations (ODEs) and the ODEs can be designed with help of a neural network to capture the continuous-time dynamics in the latent space. To that end, some embodiments use the autoencoder using neural ODEs capturing the continuous-time dynamics of the device in the latent space. Doing this in such a manner allows for imbalance training of the autoencoder during training stage, and the state space transformation during inference stage.

Accordingly, one embodiment discloses an artificial intelligence (AI) system for sensing a state of a device with continuous-time dynamics. The AI system includes a neural network having an autoencoder architecture adapted for dynamic transformation of time series input data from an input state space indicative of the state of the device into an output state space indicative of the state of the device. The AI system comprises at least one processor; and a memory having instructions stored thereon that cause the at least one processor to execute the neural network, train the neural network, or both. The autoencoder architecture comprises an encoder configured to encode each input data point of the time series input data from the input state space into a latent space to produce latent data points indexed in time according to time indices of corresponding input data points and propagate the latent data points backward in time with a neural ODE approximating dynamics of the device in the latent space to estimate an initial point of latent dynamics of the device in the latent space; a latent subnetwork configured to propagate the initial point of latent dynamics of the device forward in time till a time index of interest using the neural ODE to produce a state of latent dynamics of the device at the time index of interest; and an extended decoder configured to decode the state of latent dynamics of the device into the output state space different from the input state space to produce output data including the state of the device at the time index of interest.

Accordingly, another embodiment discloses a method for sensing a state of a device with continuous-time dynamics. The method comprises encoding each input data point of the time series input data from the input state space into a latent space to produce latent data points indexed in time according to time indices of corresponding input data points, propagating the latent data points backward in time with a neural ODE approximating dynamics of the device in the latent space to estimate an initial point of latent dynamics of the device in the latent space; propagating the initial point of latent dynamics of the device forward in time till a time index of interest using the neural ODE to produce a state of latent dynamics of the device at the time index of interest; and decoding the state of latent dynamics of the device into the output state space different from the input state space to produce output data including the state of the device at the time index of interest.

Accordingly, yet another embodiment discloses a non-transitory computer readable storage medium embodied thereon a program executable by a processor for performing a method a method for sensing a state of a device with continuous-time dynamics. The method comprises encoding each input data point of the time series input data from the input state space into a latent space to produce latent data points indexed in time according to time indices of corresponding input data points, propagating the latent data points backward in time with a neural ODE approximating dynamics of the device in the latent space to estimate an initial point of latent dynamics of the device in the latent space; propagating the initial point of latent dynamics of the device forward in time till a time index of interest using the neural ODE to produce a state of latent dynamics of the device at the time index of interest; and decoding the state of latent dynamics of the device into the output state space different from the input state space to produce output data including the state of the device at the time index of interest.

### BRIEF DESCRIPTION OF THE DRAWINGS

FIG. 1A shows an architecture of an autoencoder, according to some embodiments of the present disclosure.

FIG. 1B shows an architecture of an autoencoder with multiple decoders, according to an embodiment of the present disclosure.

FIG. 1C illustrates an autoencoder with a neural Ordinary Differential Equation (ODE), according to some embodiments of the present disclosure.

FIG. 1D shows an architecture of the autoencoder during inference stage, according to some embodiments of the present disclosure.

FIG. 2 illustrates a detailed implementation and training of the autoencoder, according to some embodiments of the present disclosure.

FIG. 3 illustrates the autoencoder for waveform reconstruction and trajectory interpolation, according to some embodiments of the present disclosure.

FIG. 4 illustrates the autoencoder for waveform reconstruction and trajectory extrapolation, according to some embodiments of the present disclosure.

FIG. 5 shows a schematic diagram of an Artificial Intelligence (AI) system for sensing a state of a device with continuous-time dynamics, according to some embodiments of the present disclosure.

FIG. 6 illustrates indoor localization of a mobile robot in an indoor space, using the AI system, according to some embodiments of the present disclosure.

FIG. 7 illustrates tracking of a location of a vehicle using the AI system, according to some embodiments of the present disclosure.

The presently disclosed embodiments will be further explained with reference to the attached drawings. The drawings shown are not necessarily to scale, with emphasis instead generally being placed upon illustrating the principles of the presently disclosed embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

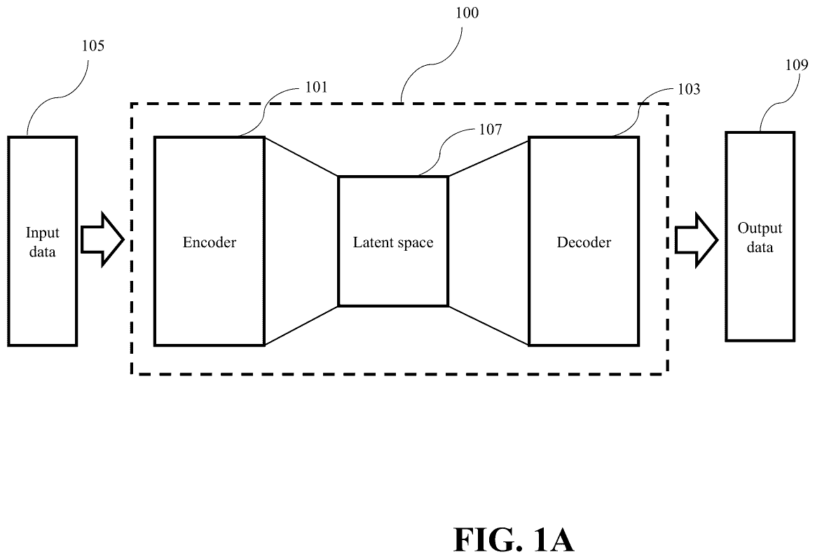

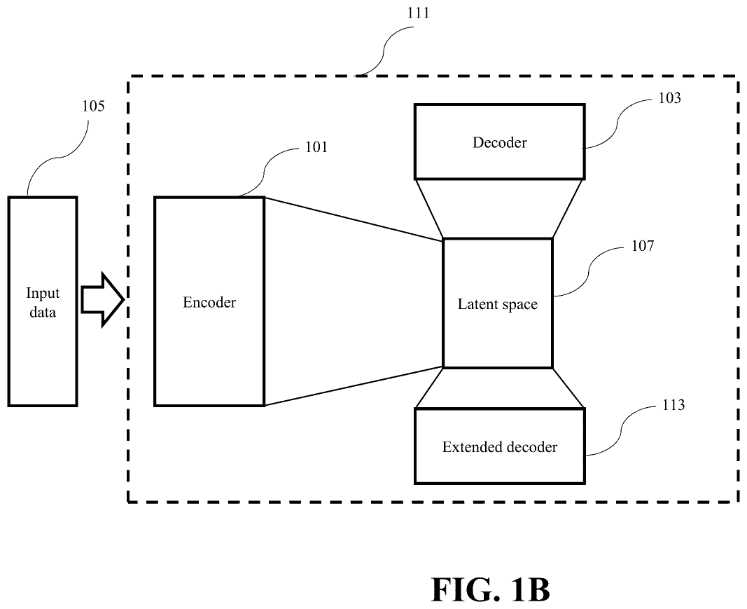

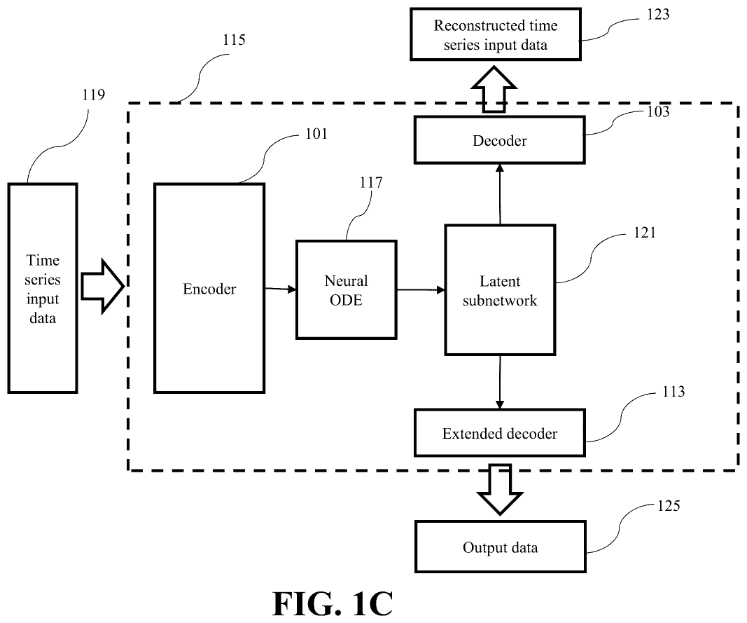

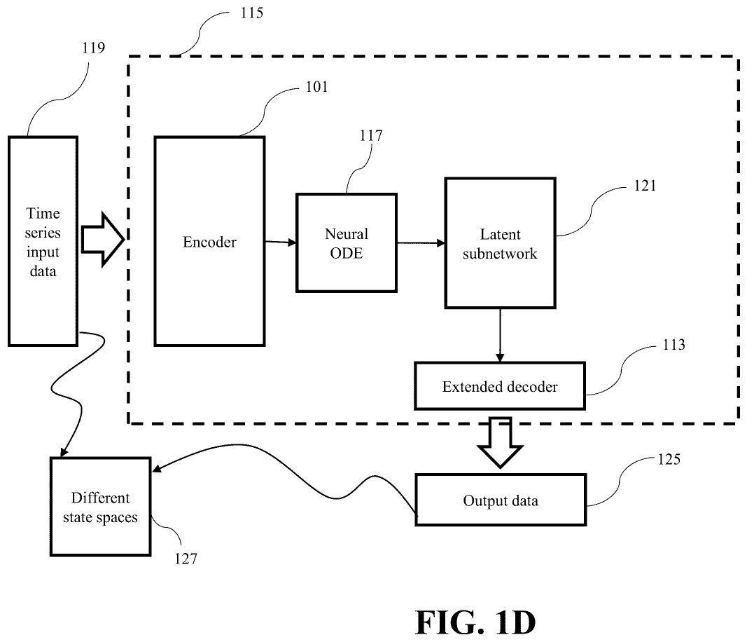

FIG. 1A shows an architecture of an autoencoder 100, according to some embodiments of the present disclosure. An autoencoder is a type of artificial neural network used to learn efficient encodings of unlabeled data (unsupervised learning). The autoencoder 100 includes an encoder 101 and a decoder 103. The encoder 101 is configured to encode each input data point of input data 105 from an input space into a latent space 107. The decoder 103 is configured to decode each encoded data point from the latent space into an output space to produce the output data 109. One of the fundamental features of the autoencoder 100 is that the input data 105 and the output data 109 belong to the same state space. A state space of the input data 105 is referred to as input state space and a state space of the output data 109 is referred to as output state space. The state space can vary based on applications. Examples of the state space include pixel intensities for face recognition applications and temperature values for thermo-comfort applications. But regardless of the applications, the input data 105 and the output data 109 of the autoencoder 100 belong to the same state space. This “limitation” has been considered a problem but rather as a feature of the autoencoder 100 allowing to perform unsupervised training of the autoencoder.

However, it is an objective of some embodiments to address this limitation to extend the autoencoder 100 to data transformation among different state spaces. Examples of such transformation include transforming signal waveform into locations, temperature into humidity, voltages into currents, etc. Such a transformation is advantageous in many technical fields including location tracking by transforming Wi-Fi signals, anomaly detection, smart grid applications, and data completeness applications.

Some embodiments are based on the realization that such state space transformation can be performed by extending the autoencoder 100 with multiple decoders. The autoencoder 100 extended with multiple decoders is described below in FIG. 1B.

FIG. 1B shows an architecture of an autoencoder 111 with multiple decoders, according to an embodiment of the present disclosure. The autoencoder 111 includes the encoder 101, the decoder 103, and an extended decoder 113. The decoder 103 decodes to the same state space as the input data 105. The decoder 103 is beneficial for enforcing principles of AI module with the autoencoder 111. The extended decoder 113 is used to train the encoder 101 to find such latent space that carries information indicative of a state space of the extended decoder 113. The objective here is to train the autoencoder 111 to find such a latent space that carries not only information of the state space of the input data 105 but the information indicative of the corresponding data in another state space of interest.

However, some embodiments are based on another realization supported by experiments, that such a state space transformation is not very practical for static data or for static devices. This is because at least in part that the latent space carrying information for more than one state space is too small to be reliable. To that end, some embodiments extended the autoencoder 111 to dynamical devices represented by autoencoders with dynamic latent space. The autoencoder 111 extended to the dynamical devices is referred to as a dynamic autoencoder.

In contrast with the static data, the dynamic autoencoder operate on time-series data that carry information about dynamics of the device. The state of such dynamic devices is represented by state variables of different state spaces. Hence, in contrast with the latent space 107 of the autoencoder 111 capturing essence of the input data 105, a latent space of the dynamic autoencoder can capture the essence of the dynamics. Because different state variables can carry redundant information about the dynamics of the device, the latent space of the dynamic autoencoder can carry information of different state variables in different state spaces allowing the state space transformation.

Some embodiments are based on the observation that to train such a dynamic autoencoder with multiple decoders decoding into different state spaces, there is a need to have labeled training data in a subset of the state space different from the input state space. The labeled training data necessitate supervised machine learning and are usually difficult to get. Hence, while in theory, any dynamical autoencoder can be extended to the multiple decoders to adapt the dynamic autoencoder to the state space transformation, in practice can be a significant imbalance between unlabeled training data from the input state space and labeled training data from a desired output state space.

To that end, it is an objective of some embodiments to adapt the dynamic autoencoder to imbalanced training with multiple decoders decoding into different and complementary state spaces. The imbalanced training includes one or a combination of different amounts of training data in different state spaces, a different time resolution of the training data in the different state spaces, a different quantization of the training data in the different state spaces, and a different time alignment of the training data in different state spaces.

Some embodiments are based on the realization that such imbalanced training can be performed for a state of the device with continuous-time dynamics because continuation of the dynamics makes the imbalance of the training data irrelevant. However, the dynamic autoencoder has a discrete nature to operations. To that end, there is a need to transform the dynamic autoencoder to capture continuous nature of the continuous-time dynamics of the device for any imbalances of the training data.

Some embodiments are based on the realization that the continuous-time dynamics can be defined by Ordinary Differential Equations (ODEs) and the ODEs can be designed with help of a neural network to capture the continuous-time dynamics in the latent space. To that end, some embodiments use the autoencoder using neural ODEs capturing the continuous-time dynamics of the device in the latent space. Doing this in such a manner allows for imbalance training of the autoencoder during training stage, and the state space transformation during inference stage.

FIG. 1C illustrates an autoencoder 115 with a neural ODE 117, according to some embodiments of the present disclosure. The autoencoder 115 is configured for dynamic transformation of time series input data 119 from an input state space indicative of the state of the device into an output state space indicative of the state of the device. The state of the device, for example, includes a location of the device. The autoencoder 115 includes an encoder 101, the neural ODE 117, a latent subnetwork 121, the decoder 103, the extended decoder 113. The encoder 101 is configured to encode each input data point of the time series input data 119 from the input state space into a latent space to produce latent data points indexed in time according to time indices of corresponding input data points. The encoder 101 is further configured to propagate the latent data points backward in time with the neural ODE 117 approximating dynamics of the device in the latent space to estimate an initial point of latent dynamics of the device in the latent space.

The latent subnetwork 121 is configured to propagate the initial point of latent dynamics of the device forward in time till a time index of interest using the neural ODE 117 to produce a state of latent dynamics of the device at the time index of interest. The decoder 103 is configured to the state of latent dynamics of the device into a state space same as the input state space to reconstruct the time series input data. To that end, the decoder 103 outputs reconstructed time series input data 123.

The extended decoder 113 is configured to decode the state of latent dynamics of the device into the output state space different from the input state space to produce output data 125 including the state of the device at the time index of interest.

In some embodiments, during inference stage, the autoencoder 115 may include only one decoder, for example, the extended decoder 113. Such an autoencoder may be used for the state space transformation during inference stage, as described below in FIG. 1D.

FIG. 1D shows an architecture of the autoencoder 115 during the inference stage, according to some embodiments of the present disclosure. During inference stage, the autoencoder 115 includes the encoder 101, the neural ODE 117, the latent subnetwork 121, and the extended decoder 113. The functions of the encoder 101, the neural ODE 117, the latent subnetwork 121, and the extended decoder 113 are same as described in FIG. 1C. Since the autoencoder 115 includes the extended decoder 125 that decodes the state of latent dynamics of the device into the output state space different from the input state space, the spate spaces of the time series input data 119 and the output data 125 are different 127. Thus, the autoencoder 115 performs state space transformation of the time series input data 123.

For example, the device is a mobile robot including a Wi-Fi receiver, the input state space is signal space parameterized on Wi-Fi measurements of the Wi-Fi receiver, the output state space is location space parametrized on coordinates of the mobile robot. In other words, the Wi-Fi measurements are applied as the time series input data 123 to the autoencoder 115, and the autoencoder 115 outputs the coordinates of the mobile robot as the output data 125. Further, the mobile robot may be tracked based on the coordinates of the mobile robot. In other words, the autoencoder 115 may be used for tracking the state of the device, i.e., the location of the device.

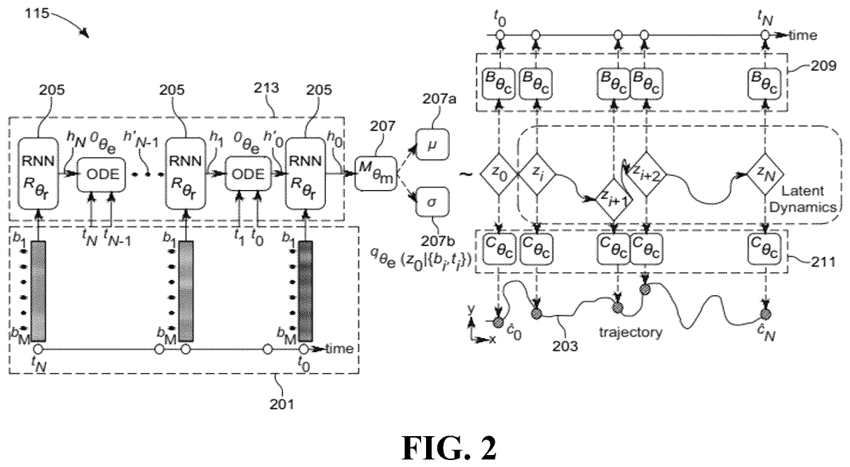

During training stage, the autoencoder 115 may include both decoders, i.e., the decoder 103 and the extended decoder 113. A detailed implementation and training of the autoencoder 155 including both the decoders for indoor localization application, is explained below in FIG. 2.

FIG. 2 illustrates a detailed implementation and training of the autoencoder 155 for indoor localization of a mobile robot, according to some embodiments of the present disclosure. The indoor localization is formulated as a sequence regression of beam training measurements within a period of ΔT_{w} seconds for trajectory estimation. Specifically, stacking M beam SNRs during one responder channel time tᵢ as bi=[b1, b2, . . . , bM]TϵR^{M×1}, the problem of interest is to utilize beam SNR measurements {bᵢ}ᵢ₌₀^{N} at time steps {tᵢ}ᵢ₌₀^{N} with irregular sample intervals to localize the device (e.g., mobile robot),

$${\{ {b}_{i} , {t}_{i} \}}_{i = 0}^{N} \to {\{ {c}_{i} \}}_{i = 0}^{N} , s . t . Δ {t}_{i} = {t}_{i} - {t}_{i - 1} \neq Δ {t}_{i + 1}$$

where cᵢ=[xᵢ, yᵢ]^{T} consists of corresponding two-dimensional coordinates (xᵢ, yᵢ) at tᵢ. In other words, trajectory estimation (i.e., estimating location of the device) is to convert a set of beam SNRs {bᵢ}ᵢ₌₀^{N} 201 at intermittently-sampled steps {tᵢ}ᵢ₌₀^{N} to a set of {cᵢ}ᵢ₌₀^{N} 203 over a continuous trajectory.

Notation: θ denotes the learnable parameters in neural networks. For simplicity, θₑ is used to denote the joint parameters of all the neural networks comprising the encoder. θₒ_{ₑ} and θₒ_{_{d}} denote parameters of the neural networks comprising the encoder and decoder ODE parts, respectively. θᵣ, θₘ, θ_{b} and θ_{c} denote parameters of Recurrent Neural Network (RNN) 205, a neural network 207 that outputs a mean 207a and a standard deviation 207b of an encoded signal, a decoder 209, and a decoder 211, respectively. The decoder 209 corresponds to the decoder 103 and the decoder 211 corresponds to the extended decoder 113. S denotes an arbitrary ODE solver.

Denote a sequence of beam SNR measurements within ΔT_{w} as {bᵢ}ᵢ₌₀^{N}ϵ [symbol] ^{N×B} and its corresponding coordinates {cᵢ}ᵢ₌₀^{N}ϵ [symbol] ^{N×2}. Input is represented as a temporal sequence to encode the underlying dynamics of variation of the mm Wave Wi-Fi signal with regard to a physical trajectory. Encoded temporal information of every measurement is obtained by forwarding the temporal inputs through an ODE-RNN network 213. The ODE-RNN network 213 corresponds an encoder. The ODE and RNN blocks are modeled as neural networks [symbol] _{θ}_{ₑ}(.) and [symbol] _{θ}_{ₑ}(.), respectively. When forwarding a beamSNR temporal sequence, time sequence is reversed from t_{N} to t₀. In this way, the encoder learns an approximate posterior at time t₀. The neural ODE blocks are used in the encoder to model evolution of the hidden states hϵ [symbol] ^{E}, where E denotes dimension of the hidden states. This behavior is modeled in a continuous fashion h(t), as a solution to an ODE initial-value problem:

$$\frac{dh ( t )}{dt} = {𝒪}_{{θ}_{{o}_{e}}} ( h ( t ) , t ) ,$$

[symbol] ₒ_{ₑ}(.) defines a time-reversed evolution of the observed beamSNR states as a solution of an ODE:

$${h}_{i - 1}^{′} = 𝒮 ( {𝒪}_{{θ}_{{o}_{e}}} , {h}_{i} , ( {t}_{i} , {t}_{i - 1} ) ) ,$$

then, the hidden state is updated for each observation as a standard RNN update:

$${h}_{i - 1} = {ℛ}_{{θ}_{r}} ( {h}_{i - 1}^{′} , {b}_{i - 1} ) .$$

Some embodiments characterize z₀ that represents a latent initial state of an encoded trajectory. To this end, the mean and the standard deviation of approximate time-reversed posterior

$${q}_{{θ}_{{o}_{e}}} ( {z}_{0} \vert {\{ {b}_{i} , {t}_{i} \}}_{i = N}^{0} )$$

are a function of a final hidden state of the encoder:

$${q}_{{θ}_{e}} ( {z}_{0} \vert {\{ {b}_{i} , {t}_{i} \}}_{i = N}^{0} ) = 𝒩 ( {μ}_{{z}_{0}} , {σ}_{{z}_{0}} ) ,$$

where

$${μ}_{{z}_{0}} , {σ}_{{z}_{0}} = {ℳ}_{{θ}_{m}} ( {𝒪}_{{θ}_{{o}_{e}}} ( {\{ {b}_{i} , {t}_{i} \}}_{i = N}^{0} ) ) ,$$

where [symbol] _{θ}_{ₘ}(.) is the neural network 207 translating the final hidden state of the encoder into the mean and variance of the latent initial state z₀.

Once estimating the approximate posterior q_{θ}_{ₑ}(z₀|{bᵢ, tᵢ}_{i=N}⁰), the beamSNR variable-length input sequence {bᵢ}ᵢ₌₀^{N} is encoded into a fixed-dimensional latent space embedding zϵ [symbol] ^{L}, where L denotes a dimension of the latent space. A latent trajectory is obtained by first sampling z₀˜q_{θe}(z₀|{bᵢ, tᵢ}_{i=N}⁰) from the estimated posterior. Then, on decoder side, another ODE [symbol] is modeled as a neural network. During training, [symbol] learns the latent trajectory dynamics that relate the variation of the signal and the physical trajectory while during forward pass, it will query the latent trajectory at the specified time instants. For these matters, z₀ is used as an initial value for the ODE solver on the decoder side:

$${z}_{0} , … , {z}_{N} = {z}_{0} + {\int }_{{t}_{0}}^{{t}_{N}} {𝒪}_{{θ}_{{o}_{d}}} ( {z}_{t} , t ) dt = 𝒮 ( {𝒪}_{{θ}_{{o}_{d}}} , {z}_{0} , ( {t}_{0} , … , {t}_{N} ) ) .$$

To this end, the beamSNR input sequence 201 has been decoded into the latent trajectory {bᵢ}ᵢ₌₀^{N}→{zᵢ}ᵢ₌₀^{N}.

Further, in order to guarantee a suitable latent trajectory learning dynamics, learning is conditioned by including two linear decoders 209 and 211 in the decoder side: waveform reconstruction [symbol] _{θ}_{_{b}}(.), and trajectory regression [symbol] _{θ}_{_{c}}(.). The latent trajectory is applied as input to the decoders 209 and 211, in order to perform the reconstruction of the input sequence 201

$${\hat{b}}_{i} = {ℬ}_{{θ}_{b}} ( {z}_{i} ) = {W}_{b} {z}_{i} + {v}_{b} ,$$

and its corresponding trajectory regression

$${\hat{c}}_{i} = {𝒞}_{{θ}_{c}} ( {z}_{i} ) = {W}_{c} {z}_{i} + {v}_{c} ,$$

where W_{b}, W_{c} denotes weight matrices and v_{b}, v_{c} bias vectors, respectively. The decoders 209 and 211 use shared weights for the input sequences 201. In this way, strong supervision is imposed for every time instant in the latent trajectory by using the physical trajectory and the variation of the signal as conditions to modify learning dynamics of the latent trajectory. This leads to an enhancement in learning the continuous dynamics of the trajectory of the device from the latent space.

Further, in some embodiments, the autoencoder 115 is trained in an end-to-end encoder-decoder structure to minimize a dual-decoder loss which is given by

$$ℒ = [ α {‖ {\hat{c}}_{0} - {c}_{0} ‖}_{1} + \frac{1}{N} {\sum }_{i = 1}^{N} {‖ {\hat{c}}_{i} - {c}_{i} ‖}_{1} ] + β [ \frac{1}{N} {\sum }_{i = 0}^{N} {‖ {\hat{b}}_{i} - {b}_{i} ‖}_{1} ]$$

where a first term corresponds to the trajectory regression, and a second term to the waveform reconstruction. Hyperparameters α and β are for balance the importance of the first term and the second term during the learning. In the first term, the first coordinate of the trajectory is weighted on its own with a factor to enhance the trajectory learning.

According to some embodiments, time complexity of an ODE-RNN depends on a number of hidden units in a recurrent layer H and a number of time steps in an input sequence T. Then, the time complexity of the forward pass of the ODE-RNN can be approximated as [symbol] (TH²). Similarly, for linear layers, an input dimension N and an output dimension M are expressed as [symbol] (NM+M). In this way, the time complexity is given as:

$$𝒪 ( T ( {H}_{e}^{2} + {H}_{d}^{2} + ( L + 1 ) ( B + C ) ) ) ,$$

where sub-indexes represent the encoder and decoder ODEs, respectively, L is the dimension of the latent space, and B and C are dimensions of the decoders, respectively.

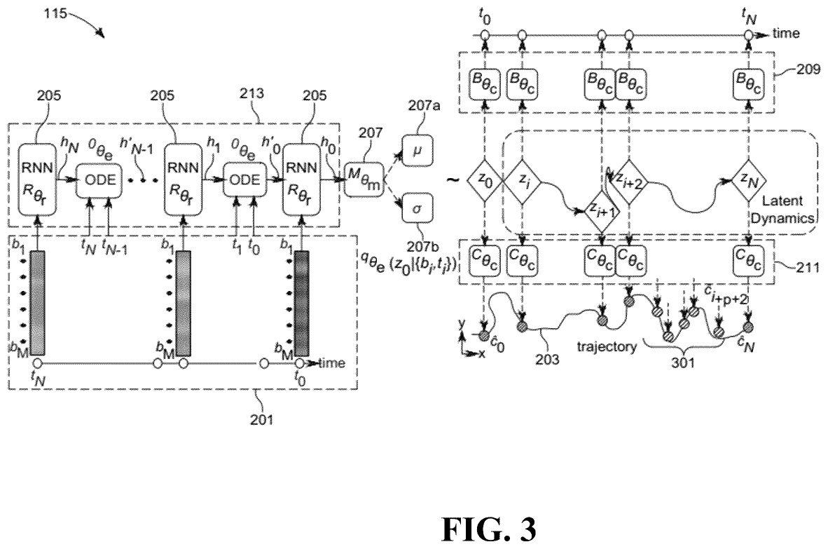

Additionally, in some embodiments, the autoencoder 115 may be used for the waveform reconstruction and trajectory interpolation. Such an embodiment is described in FIG. 3.

FIG. 3 illustrates the autoencoder 115 for waveform reconstruction and trajectory interpolation, according to some embodiments of the present disclosure. The decoder 209 reconstructs the input sequence 201, and the decoder 211 regresses device locations not only at the time instance of the input sequence 201 but also other time instances 301 in between two consecutive time instances of the input sequence 201, based on the state of latent dynamics of the device.

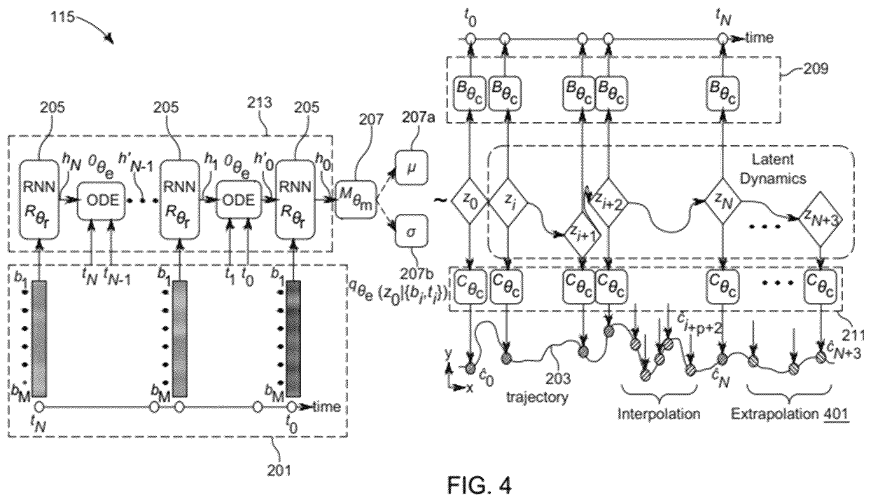

Additionally, in some embodiments, the autoencoder 115 may be used for the waveform reconstruction and trajectory extrapolation. Such an embodiment is described in FIG. 4.

FIG. 4 illustrates the autoencoder 115 for waveform reconstruction and trajectory extrapolation, according to some embodiments of the present disclosure. The decoder 209 reconstructs the input sequence 201 and the decoder 211 regresses, based on the state of latent dynamics of the device, device locations not only at the time instance of the input sequence, other time instances in between two consecutive time instances of the input sequence 201, and future time instances 401 for extrapolating or predicting the trajectory 203 ĉ_{N} to ĉ_{N+3}.

In some embodiments, the autoencoder 115 may include a plurality of extended decoders. Each extended decoder decodes the state of latent dynamics into a different state space different from the input state space. Such an autoencoder allows different state space transformations or a desired state space transformation.

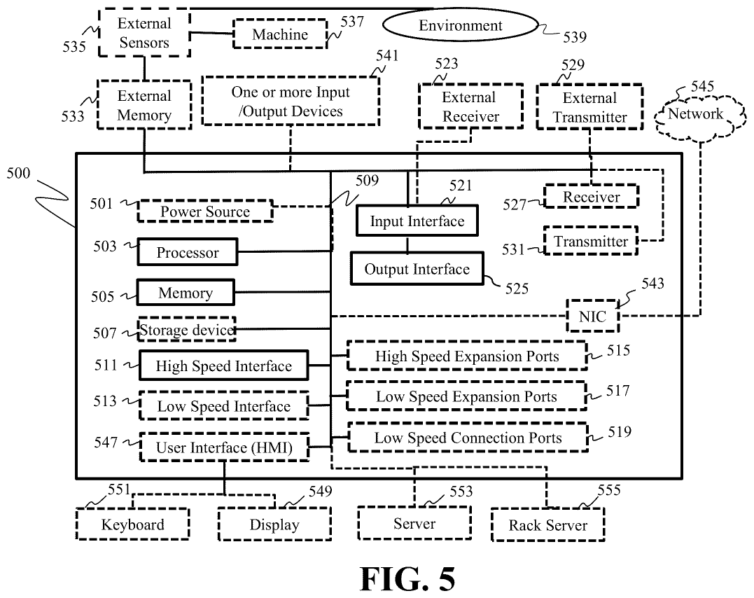

FIG. 5 shows a schematic diagram of an Artificial Intelligence (AI) system 500 for sensing the state of the device with continuous-time dynamics, according to some embodiments of the present disclosure. The AI system 500 includes a power source 501, a processor 503, a memory 505, a storage device 507, all connected to a bus 509. Further, a high-speed interface 511, a low-speed interface 513, high-speed expansion ports 515 and low speed connection ports 517, can be connected to the bus 509. In addition, a low-speed expansion port 519 is in connection with the bus 509. Further, an input interface 521 can be connected via the bus 509 to an external receiver 523 and an output interface 525. A receiver 527 can be connected to an external transmitter 529 and a transmitter 531 via the bus 509. Also connected to the bus 509 can be an external memory 533, external sensors 535, machine(s) 537, and an environment 539. Further, one or more external input/output devices 541 can be connected to the bus 509. A network interface controller (NIC) 543 can be adapted to connect through the bus 509 to a network 545, wherein data or other data, among other things, can be rendered on a third-party display device, third party imaging device, and/or third-party printing device outside of the AI system 500.

The memory 505 can store instructions that are executable by the AI system 500 and any data that can be utilized by the methods and systems of the present disclosure. The memory 505 can include random access memory (RAM), read only memory (ROM), flash memory, or any other suitable memory systems. The memory 505 can be a volatile memory unit or units, and/or a non-volatile memory unit or units. The memory 505 may also be another form of computer-readable medium, such as a magnetic or optical disk.

The storage device 507 can be adapted to store supplementary data and/or software modules used by the computer device 500. The storage device 507 can include a hard drive, an optical drive, a thumb-drive, an array of drives, or any combinations thereof. Further, the storage device 507 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 503), perform one or more methods, such as those described above.

In an embodiment, the storage device 507 is configured to store a neural network having an autoencoder architecture (e.g., the autoencoder 115) adapted for dynamic transformation of time series input data from an input state space indicative of the state of the device into an output state space indicative of the state of the device. The memory 505 may store instructions that cause the processor 503 to execute the neural network having the autoencoder architecture (e.g., the autoencoder 115), train the neural network, or both.

The AI system 500 can be linked through the bus 509, optionally, to a display interface or user Interface (HMI) 547 adapted to connect the AI system 500 to a display device 549 and a keyboard 551, wherein the display device 549 can include a computer monitor, camera, television, projector, or mobile device, among others. In some implementations, the computer device 500 may include a printer interface to connect to a printing device, wherein the printing device can include a liquid inkjet printer, solid ink printer, large-scale commercial printer, thermal printer, UV printer, or dye-sublimation printer, among others.

The high-speed interface 511 manages bandwidth-intensive operations for the AI system 500, while the low-speed interface 513 manages lower bandwidth-intensive operations. Such allocation of functions is an example only. In some implementations, the high-speed interface 511 can be coupled to the memory 505, the user interface (HMI) 545, and to the keyboard 551 and the display 549 (e.g., through a graphics processor or accelerator), and to the high-speed expansion ports 515, which may accept various expansion cards via the bus 509. In an implementation, the low-speed interface 513 is coupled to the storage device 507 and the low-speed expansion ports 517, via the bus 509. The low-speed expansion ports 517, which may include various communication ports (e.g., USB, Bluetooth, Ethernet, wireless Ethernet) may be coupled to the one or more input/output devices 541. The AI system 500 may be connected to a server 553 and a rack server 555. The AI system 500 may be implemented in several different forms. For example, the AI system 500 may be implemented as part of the rack server 555.

In an embodiment, the device may be a mobile robot, and the AI system can be used to track a state of the mobile robot, e.g., a location of the mobile robot, in an indoor space. In other words, the AI system can be used for indoor localization of the mobile robot.

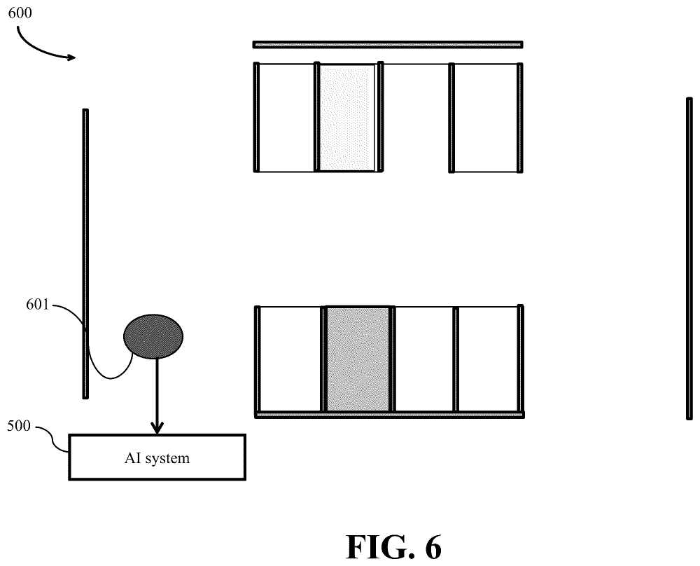

FIG. 6 illustrates indoor localization of a mobile robot 601 in an indoor space 600, using the AI system 500, according to some embodiments of the present disclosure. The indoor space 600 may be an autonomous factory, a warehouse, or a smart home, where asset (such as robot) tracking is required or crucial. The mobile robot 601 is communicatively coupled to the AI system 500.

The AI system includes the autoencoder 115. The mobile robot 601 includes a Wi-Fi receiver. The AI system 500 receives Wi-Fi measurements of the Wi-Fi receiver and applies the Wi-Fi measurements as input data to the autoencoder 115. The autoencoder 115 processes the Wi-Fi measurements, and outputs coordinates of the mobile robot as output data. The mobile robot 601 may tracked based on the coordinates of the mobile robot. Here, the state space of the input data is a signal space parameterized on the Wi-Fi measurements of the Wi-Fi receiver, and the state space of the output data is a location space parametrized on the coordinates of the mobile robot. Thus, the autoencoder 115 performs state space transformation by transforming data from the signal space to the location space.

Additionally, in some embodiments, the device is a vehicle, and the AI system 500 can be used for tracking a location of the vehicle. Here, the input state space is a signal space parametrized on acceleration measurements of the vehicle, and the output state space is a location space parametrized on coordinates of the vehicle.

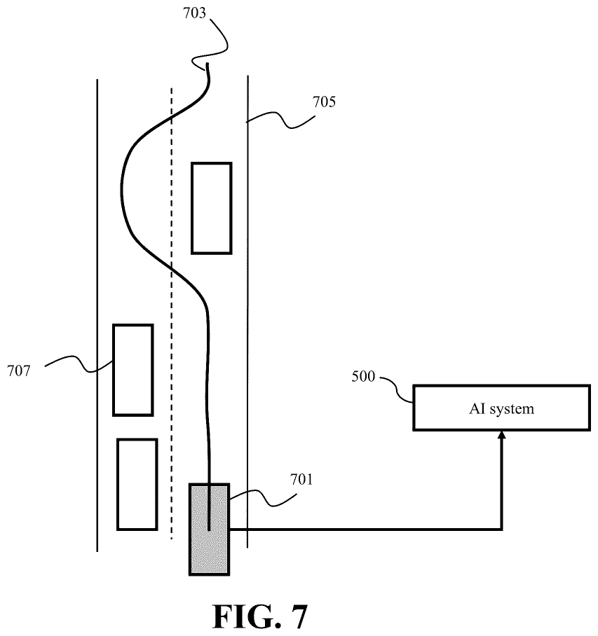

FIG. 7 illustrates tracking of a location of a vehicle 701 using the AI system 500, according to some embodiments of the present disclosure. The vehicle 701 may be configured to move along a trajectory 703 on a road 705 while avoiding obstacle vehicles 707. The AI system 500 is communicatively coupled to the vehicle 701. The AI system receives measurements of acceleration of the vehicle 701. The AI system 500 processes the received measurements of acceleration of the vehicle 701 with the autoencoder 115 and outputs coordinates of the vehicle 701. Based on the coordinates of the vehicle 701, the location of the vehicle 701 may be tracked.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

Claimed is:

1. An Artificial Intelligence (AI) system for sensing a state of a device with continuous-time dynamics, the AI system including a neural network having an autoencoder architecture adapted for dynamic transformation of time series input data from an input state space indicative of the state of the device into an output state space indicative of the state of the device, comprising: at least one processor; and a memory having instructions stored thereon that cause the at least one processor to execute the neural network, train the neural network, or both, the autoencoder architecture comprising:
an encoder configured to encode each input data point of the time series input data from the input state space into a latent space to produce latent data points indexed in time according to time indices of corresponding input data points and propagate the latent data points backward in time with a neural Ordinary Differential Equation (ODE) approximating dynamics of the device in the latent space to estimate an initial point of latent dynamics of the device in the latent space;
a latent subnetwork configured to propagate the initial point of latent dynamics of the device forward in time till a time index of interest using the neural ODE to produce a state of latent dynamics of the device at the time index of interest; and
an extended decoder configured to decode the state of latent dynamics of the device into the output state space different from the input state space to produce output data including the state of the device at the time index of interest.

2. The AI system of claim 1, wherein the autoencoder architecture further comprising a decoder configured to decode the state of latent dynamics of the device into the output state space same as the input state space to reconstruct the time series input data.

3. The AI system of claim 1, wherein the state of the device corresponds to a trajectory of the device, and wherein the extended decoder is further configured to interpolate the trajectory of the device based on the state of latent dynamics of the device.

4. The AI system of claim 3, wherein the extended decoder is further configured to extrapolate the trajectory of the device based on the state of latent dynamics of the device.

5. The AI system of claim 1, wherein the autoencoder architecture includes a plurality of extended decoders, and wherein each extended decoder of the plurality of extended decoders is configured to decode the state of latent dynamics into a different state space different from the input state space.

6. The AI system of claim 1, wherein the device is a mobile robot including a Wi-Fi receiver, wherein the input state space is a signal space parameterized on Wi-Fi measurements of the Wi-Fi receiver, and wherein the output state space is a location space parametrized on coordinates of the mobile robot.

7. The AI system of claim 1, wherein the device is a vehicle, wherein the input state space is a signal space parametrized on acceleration measurements of the vehicle, and wherein the output state space is a location space parametrized on coordinates of the vehicle.

8. A method for sensing a state of a device with continuous-time dynamics, comprising:
encoding each input data point of time series input data from an input state space into a latent space to produce latent data points indexed in time according to time indices of corresponding input data points,
propagating the latent data points backward in time with a neural Ordinary Differential Equation (ODE) approximating dynamics of the device in the latent space to estimate an initial point of latent dynamics of the device in the latent space;
propagating the initial point of latent dynamics of the device forward in time till a time index of interest using the neural ODE to produce a state of latent dynamics of the device at the time index of interest; and
decoding the state of latent dynamics of the device into an output state space different from the input state space to produce output data including the state of the device at the time index of interest.

9. The method of claim 8, further comprising decoding the state of latent dynamics of the device into the output state space same as the input state space to reconstruct the time series input data.

10. The method of claim 8, wherein the state of the device corresponds to trajectory of the device, and wherein the method further comprises interpolating the trajectory of the device based on the state of latent dynamics of the device.

11. The method of claim 10, wherein the method further comprises extrapolating the trajectory of the device based on the state of latent dynamics of the device.

12. The method of claim 8, wherein the device is a mobile robot including a Wi-Fi receiver, wherein the input state space is a signal space parameterized on Wi-Fi measurements of the Wi-Fi receiver, and wherein the output state space is a location space parametrized on coordinates of the mobile robot.

13. The method of claim 8, wherein the device is a vehicle, wherein the input state space is a signal space parametrized on acceleration measurements of the vehicle, and wherein the output state space is a location space parametrized on coordinates of the vehicle.

14. A non-transitory computer readable storage medium embodied thereon a program executable by a processor for performing a method for sensing a state of a device with continuous-time dynamics, the method comprising:
encoding each input data point of time series input data from an input state space into a latent space to produce latent data points indexed in time according to time indices of corresponding input data points,
propagating the latent data points backward in time with a neural Ordinary Differential Equation (ODE) approximating dynamics of the device in the latent space to estimate an initial point of latent dynamics of the device in the latent space;
propagating the initial point of latent dynamics of the device forward in time till a time index of interest using the neural ODE to produce a state of latent dynamics of the device at the time index of interest; and
decoding the state of latent dynamics of the device into an output state space different from the input state space to produce output data including the state of the device at the time index of interest.

15. The non-transitory computer readable storage medium of claim 14, the method further comprising decoding the state of latent dynamics of the device into the output state space same as the input state space to reconstruct the time series input data.

16. The non-transitory computer readable storage medium of claim 14, wherein the state of the device corresponds to a trajectory of the device, and wherein the method further comprises interpolating the trajectory of the device based on the state of latent dynamics of the device.

17. The non-transitory computer readable storage medium of claim 16, wherein the method further comprises extrapolating the trajectory of the device based on the state of latent dynamics of the device.

18. The non-transitory computer readable storage medium of claim 14, wherein the device is a mobile robot including a Wi-Fi receiver, wherein the input state space is a signal space parameterized on Wi-Fi measurements of the Wi-Fi receiver, and wherein the output state space is a location space parametrized on coordinates of the mobile robot.

19. The non-transitory computer readable storage medium of claim 14, wherein the device is a vehicle, wherein the input state space is a signal space parametrized on acceleration measurements of the vehicle, and wherein the output state space is a location space parametrized on coordinates of the vehicle.
